(19) United States
(12) Patent Application Publication
(10) Pub. No.: US 2026/0223245 A1
(43) Pub. Date: Jul. 30, 2026

(54) METHOD AND APPARATUS FOR MANAGING SCHEDULING REQUEST FOR NETWORK ENERGY SAVINGS IN WIRELESS COMMUNICATION SYSTEM

(71) Applicant: Samsung Electronics Co., Ltd., Suwon-si, Gyeonggi-do (KR)

(72) Inventors: Vinay Kumar SHRIVASTAVA, Bangalore (IN); Aby Kanneath ABRAHAM, Bangalore (IN); Diwakar SHARMA, Bangalore (IN); Santanu MONDAL, Bangalore (IN); Sriganesh RAJENDRAN, Bangalore (IN)

(21) Appl. No.: 19/149,749

(22) PCT Filed: Jan. 19, 2024
(86) PCT No.: PCT/KR2024/000997

§ 371 Date: Jul. 21, 2025

(30) Foreign Application Priority Data
Jan. 19, 2023 (IN) 202341003850
Dec. 29, 2023 (IN) 2023 41003850

(51) Int. Cl. H04W 76/28; H04W 72/1263

(52) U.S. Cl. CPC H04W 76/28; H04W 72/1263

(57) ABSTRACT

The disclosure relates to a 5G or 6G communication system for supporting a higher data transmission rate. A method performed by a user equipment (UE) is provided. The method includes receiving, from a base station, configuration information for a cell discontinuous reception (DRX), identifying whether the cell DRX is activated and a serving cell is not in an active reception period of the cell DRX based on the configuration information, and in case that the cell DRX is activated and the serving cell is not in the active reception period of the cell DRX, determining not to transmit a scheduling request (SR).

### TECHNICAL FIELD

Embodiments disclosed herein relate to wireless communication networks, and more particularly to enhanced methods and systems for managing Scheduling Request (SR) for Network Energy Saving (NES) in wireless communication networks.

### BACKGROUND ART

5G mobile communication technologies define broad frequency bands such that high transmission rates and new services are possible, and can be implemented not only in “Sub 6 GHz” bands such as 3.5 GHz, but also in “Above 6 GHz” bands referred to as mmWave including 28 GHz and 39 GHz. In addition, it has been considered to implement 6G mobile communication technologies (referred to as Beyond 5G systems) in terahertz bands (for example, 95 GHz to 3 THz bands) in order to accomplish transmission rates fifty times faster than 5G mobile communication technologies and ultra-low latencies one-tenth of 5G mobile communication technologies.

At the beginning of the development of 5G mobile communication technologies, in order to support services and to satisfy performance requirements in connection with enhanced Mobile BroadBand (eMBB), Ultra Reliable Low Latency Communications (URLLC), and massive Machine-Type Communications (mMTC), there has been ongoing standardization regarding beamforming and massive MIMO for mitigating radio-wave path loss and increasing radio-wave transmission distances in mmWave, supporting numerologies (for example, operating multiple subcarrier spacings) for efficiently utilizing mmWave resources and dynamic operation of slot formats, initial access technologies for supporting multi-beam transmission and broadbands, definition and operation of BWP (BandWidth Part), new channel coding methods such as a LDPC (Low Density Parity Check) code for large amount of data transmission and a polar code for highly reliable transmission of control information, L2 pre-processing, and network slicing for providing a dedicated network specialized to a specific service.

Currently, there are ongoing discussions regarding improvement and performance enhancement of initial 5G mobile communication technologies in view of services to be supported by 5G mobile communication technologies, and there has been physical layer standardization regarding technologies such as V2X (Vehicle-to-everything) for aiding driving determination by autonomous vehicles based on information regarding positions and states of vehicles transmitted by the vehicles and for enhancing user convenience, NR-U (New Radio Unlicensed) aimed at system operations conforming to various regulation-related requirements in unlicensed bands, NR UE Power Saving, Non-Terrestrial Network (NTN) which is UE-satellite direct communication for providing coverage in an area in which communication with terrestrial networks is unavailable, and positioning.

Moreover, there has been ongoing standardization in air interface architecture/protocol regarding technologies such as Industrial Internet of Things (IIoT) for supporting new services through interworking and convergence with other industries, IAB (Integrated Access and Backhaul) for providing a node for network service area expansion by supporting a wireless backhaul link and an access link in an integrated manner, mobility enhancement including conditional handover and DAPS (Dual Active Protocol Stack) handover, and two-step random access for simplifying random access procedures (2-step RACH for NR). There also has been ongoing standardization in system architecture/service regarding a 5G baseline architecture (for example, service based architecture or service based interface) for combining Network Functions Virtualization (NFV) and Software-Defined Networking (SDN) technologies, and Mobile Edge Computing (MEC) for receiving services based on UE positions.

As 5G mobile communication systems are commercialized, connected devices that have been exponentially increasing will be connected to communication networks, and it is accordingly expected that enhanced functions and performances of 5G mobile communication systems and integrated operations of connected devices will be necessary. To this end, new research is scheduled in connection with extended Reality (XR) for efficiently supporting AR (Augmented Reality), VR (Virtual Reality), MR (Mixed Reality) and the like, 5G performance improvement and complexity reduction by utilizing Artificial Intelligence (AI) and Machine Learning (ML), AI service support, metaverse service support, and drone communication.

Furthermore, such development of 5G mobile communication systems will serve as a basis for developing not only new waveforms for providing coverage in terahertz bands of 6G mobile communication technologies, multi-antenna transmission technologies such as Full Dimensional MIMO (FD-MIMO), array antennas and large-scale antennas, metamaterial-based lenses and antennas for improving coverage of terahertz band signals, high-dimensional space multiplexing technology using OAM (Orbital Angular Momentum), and RIS (Reconfigurable Intelligent Surface), but also fullduplex technology for increasing frequency efficiency of 6G mobile communication technologies and improving system networks, AI-based communication technology for implementing system optimization by utilizing satellites and AI (Artificial Intelligence) from the design stage and internalizing end-to-end AI support functions, and next-generation distributed computing technology for implementing services at levels of complexity exceeding the limit of UE operation capability by utilizing ultra-high-performance communication and computing resources.

Network Energy Saving (NES) has become significant, considering the ever-increasing power consumption by wireless networks (that serve multiple User Equipments (UEs)), and the associated high costs. For enabling energy efficiency for networks operations (more particularly, for the transmission and the reception by the Radio Access Network (RAN) nodes that account for 22 percent of the overall power consumption by the communication networks), there is a need for efficient approaches that can achieve energy savings for the networks. Some of these approaches may include a special operation mode (for example, termed as NES mode), wherein the network nodes may apply discontinuous transmission (DTX) and/or discontinuous reception (DRX) to curtail power consumption by the nodes.

One potential issue with the NES approaches could be a potential conflict or ambiguity for the Scheduling Request (SR) procedure of the UE, when operating with the radio cell/network node that employs NES. SR procedure for the UE is based on the uplink data arrival and is independent of the network state. As a result, there is a need to enhance the existing SR procedures for the UE to enable a graceful coexistence with NES approaches as employed by the network nodes.

Hence, there is a need in the art for solutions which will overcome the above mentioned drawback(s), among others.

### DISCLOSURE OF INVENTION

### Technical Problem

The principal object of embodiments herein is to disclose methods and systems for managing Scheduling Request (SR) for Network Energy Saving (NES) in a wireless communication network, wherein a User Equipment (UE) can decide on whether to send/not send a SR to a cell, based on the current Cell-DRX state of the cell.

Another object of embodiments herein is to disclose methods and systems for the UE to determine the state of a cell (i.e., if the cell is in a Cell-DRX state and/or a Cell-DTX state or not).

### Solution to Problem

In an embodiment, a method performed by a user equipment (UE) is provided. The method includes receiving, from a base station, configuration information for a cell discontinuous reception (DRX), identifying whether the cell DRX is activated and a serving cell is not in an active reception period of the cell DRX based on the configuration information, and in case that the cell DRX is activated and the serving cell is not in the active reception period of the cell DRX, determining not to transmit a scheduling request (SR).

In an embodiment, a method performed by a base station is provided. The method includes transmitting, to a user equipment (UE), configuration information for a cell discontinuous reception (DRX), identifying whether the cell DRX is activated and a serving cell is not in an active reception period of the cell DRX according to the configuration information, and in case that the cell DRX is activated and the serving cell is not in the active reception period of the cell DRX, determining not to receive a scheduling request (SR).

In an embodiment, a UE in a wireless communication system is provided. The UE includes a transceiver and a controller. The controller is configured to receive, from a base station via the transceiver, configuration information for a cell discontinuous reception (DRX), identify whether the cell DRX is activated and a serving cell is not in an active reception period of the cell DRX based on the configuration information, and in case that the cell DRX is activated and the serving cell is not in the active reception period of the cell DRX, determine not to transmit a scheduling request (SR).

In an embodiment, a base station in a wireless communication system is provided. The base station includes a transceiver and a controller. The controller is configured to transmit, to a user equipment (UE) via the transceiver, configuration information for a cell discontinuous reception (DRX), identify whether the cell DRX is activated and a serving cell is not in an active reception period of the cell DRX according to the configuration information, and in case that the cell DRX is activated and the serving cell is not in the active reception period of the cell DRX, determine not to receive a scheduling request (SR).

Accordingly, the embodiments herein provide a method for managing Scheduling Request (SR) for Network Energy Saving (NES) in a wireless communication network. The method comprises a User Equipment (UE) checking if a serving cell is in a Cell-DRX state; and defer transmitting the SR to the serving cell until the serving cell comes out of the Cell-DRX state, if the serving cell is in the Cell-DRX state.

Accordingly, the embodiments herein provide a method for determining state of a cell in a wireless communication network. The method comprises the UE determining if the cell is in at least one of a Cell-DRX state; and a Cell-DTX state. The UE can determine if the cell is in at least one of the Cell-DRX state; and the Cell-DTX state if the UE is at least one of configured; and activated with Network Energy Saving (NES) mode by the cell, the UE is at least one of configured; and activated with at least one NES configuration by the cell, and/or the UE is operating in a network node employing NES mode.

Accordingly, the embodiments herein provide a User Equipment (UE) comprising a memory; and a Medium Access Control (MAC) entity. The MAC entity is coupled with the processor and the memory, and is configured to check if a serving cell is in a Cell-DRX state; and defer transmitting a Scheduling Request (SR) to the serving cell until the serving cell comes out of the Cell-DRX state, if the serving cell is in the Cell-DRX state.

Accordingly, the embodiments herein provide a User Equipment (UE) comprising a memory; and a Medium Access Control (MAC) entity. The MAC entity is coupled with the processor and the memory, and is configured to determine if a cell is in at least one of a Cell-DRX state; and a Cell-DTX state. The MAC entity can determine that the cell is in at least one of the Cell-DRX state; and the Cell-DTX state, if the UE is at least one of configured; and activated with Network Energy Saving (NES) mode by the cell; the UE is at least one of configured; and activated with at least one NES configuration by the cell; and/or the UE is operating in a network node employing NES mode.

These and other aspects of the embodiments herein will be better appreciated and understood when considered in conjunction with the following description and the accompanying drawings. It should be understood, however, that the following descriptions, while indicating at least one embodiment and numerous specific details thereof, are given by way of illustration and not of limitation. Many changes and modifications may be made within the scope of the embodiments herein without departing from the spirit thereof, and the embodiments herein include all such modifications.

### BRIEF DESCRIPTION OF DRAWINGS

Embodiments herein are illustrated in the accompanying drawings, throughout which like reference letters indicate corresponding parts in the various figures. The embodiments herein will be better understood from the following description with reference to the following illustratory drawings. Embodiments herein are illustrated by way of examples in the accompanying drawings, and in which:

FIG. 1 depicts a wireless communication network comprising a user equipment (UE) and the serving cell, according to embodiments as disclosed herein;

FIGS. 2A and 2B depict a process for managing the transmission of SR to a serving cell, according to embodiments as disclosed herein;

FIG. 3 is a flowchart depicting the process of the UE determining whether to transmit the SR based on the Cell-DRX state of the serving cell, according to embodiments as disclosed herein; and

FIG. 4 is a flowchart depicting the process of the UE determining that the network is in a Cell-DRX state, based on the Cell-DRX configuration parameter (on-durationTimer), according to embodiments as disclosed herein.

FIG. 5 is a diagram illustrating a UE 500 according to another embodiment of the present disclosure.

FIG. 6 is a diagram illustrating a base station 600 according to another embodiment of the present disclosure.

### MODE FOR THE INVENTION

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. The examples used herein are intended merely to facilitate an understanding of ways in which the embodiments herein may be practiced and to further enable those of skill in the art to practice the embodiments herein. Accordingly, the examples should not be construed as limiting the scope of the embodiments herein.

For the purposes of interpreting this specification, the definitions (as defined herein) will apply and whenever appropriate the terms used in singular will also include the plural and vice versa. It is to be understood that the terminology used herein is for the purposes of describing particular embodiments only and is not intended to be limiting. The terms “comprising”, “having” and “including” are to be construed as open-ended terms unless otherwise noted.

The words/phrases “exemplary”, “example”, “illustration”, “in an instance”, “and the like”, “and so on”, “etc.”, “etcetera”, “e.g.,”, “i.e.,” are merely used herein to mean “serving as an example, instance, or illustration.” Any embodiment or implementation of the present subject matter described herein using the words/phrases “exemplary”, “example”, “illustration”, “in an instance”, “and the like”, “and so on”, “etc.”, “etcetera”, “e.g.,”, “i.e.,” is not necessarily to be construed as preferred or advantageous over other embodiments.

Embodiments herein may be described and illustrated in terms of blocks which carry out a described function or functions. These blocks, which may be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits, and the like, and may optionally be driven by a firmware. The circuits may, for example, be embodied in one or more semiconductor chips, or on substrate supports such as printed circuit boards and the like. The circuits constituting a block may be implemented by dedicated hardware, or by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

It should be noted that elements in the drawings are illustrated for the purposes of this description and ease of understanding and may not have necessarily been drawn to scale. For example, the flowcharts/sequence diagrams illustrate the method in terms of the steps required for understanding of aspects of the embodiments as disclosed herein. Furthermore, in terms of the construction of the device, one or more components of the device may have been represented in the drawings by conventional symbols, and the drawings may show only those specific details that are pertinent to understanding the present embodiments so as not to obscure the drawings with details that will be readily apparent to those of ordinary skill in the art having the benefit of the description herein. Furthermore, in terms of the system, one or more components/modules which comprise the system may have been represented in the drawings by conventional symbols, and the drawings may show only those specific details that are pertinent to understanding the present embodiments so as not to obscure the drawings with details that will be readily apparent to those of ordinary skill in the art having the benefit of the description herein.

The accompanying drawings are used to help easily understand various technical features and it should be understood that the embodiments presented herein are not limited by the accompanying drawings. As such, the present disclosure should be construed to extend to any modifications, equivalents, and substitutes in addition to those which are particularly set out in the accompanying drawings and the corresponding description. Usage of words such as first, second, third etc., to describe components/elements/steps is for the purposes of this description and should not be construed as sequential ordering/placement/occurrence unless specified otherwise.

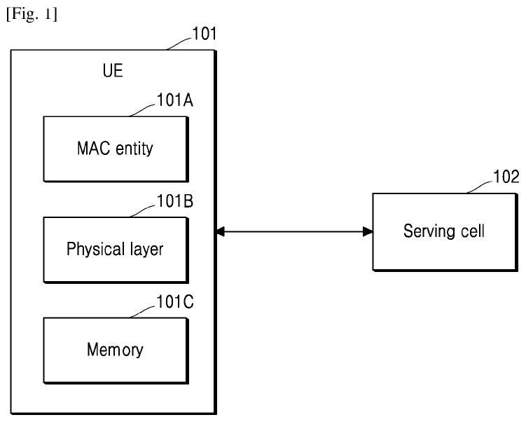

The embodiments herein achieve methods and systems for managing Scheduling Requests (SRs) for Network Energy Saving (NES) in a wireless communication network. Referring now to the drawings, and more particularly to FIGS. 1 through 4, where similar reference characters denote corresponding features consistently throughout the figures, there are shown embodiments.

Embodiments herein disclose methods and systems for managing Scheduling Request (SR) for Network Energy Saving (NES) in a wireless communication network. If a SR transmission counter is less than a threshold, a User Equipment (UE) can instruct a physical layer in a UE to transmit the SR to a cell on a valid Physical Uplink Control Channel (PUCCH) resource, when the serving cell is not in the Cell-DRX state. Further, if the serving cell is in the Cell-DRX state, the UE can defer to instruct the physical layer to signal the SR to the cell, until the serving cell comes out of the Cell-DRX state.

FIG. 1 depicts a wireless communication network. The wireless communication network 100, as depicted, comprises at least one UE 101, and at least one cell 102. Consider that the cell 102 is a serving cell for the UE 101. In an embodiment herein, the network 100 can comprise of one or more other cells (not shown), which can also provide one or more services to the UE 101.

The UE 101 can further comprise a Medium Access Control (MAC) entity 101A, a physical layer 101B, and a memory 101C. In an embodiment herein, consider that the UE 101 is configured with a NES mode. In an embodiment herein, consider that the UE 101 is configured with at least one NES configuration by the network 100. In an embodiment herein, consider that the UE 101 is operating in a network node employing a NES mode. The NES configuration can comprise of one or more Cell-DRX and/or Cell-DTX configurations that can be applied together or independently. The Cell-DRX and/or Cell-DTX configurations may be configured and/or activated and/or deactivated per cell basis for one or more cells. The Cell-DRX and/or Cell-DTX configuration may further comprise of one or more parameters including a periodicity parameter, a start slot/offset parameter, an on-duration window parameter, and an on-duration Timer parameter. Based on the configured parameters for one or more Cell-DRX and/or Cell-DTX configurations, the MAC entity 101A can determine the time duration when the Cell-DRX state and/or Cell-DTX state is applicable for the cell (e.g. when on-duration Timer of the Cell-DRX and/or Cell-DTX configuration is not running). The MAC entity 101A can align its transmission to the network and/or align its Connected-mode DRX/Idle-mode DRX, to the time duration when the cell is not in the Cell-DRX state.

Consider that the UE 101 wants to transmit a SR to the serving cell. The MAC entity 101A can check a value of a SR transmission counter (SR_Counter). The SR transmission counter can indicate the number of times that the UE 101 has transmitted the SR. The MAC entity 101A can check if the SR transmission counter is less than a pre-defined or pre-configured threshold (hereinafter termed as sr-TransMax). The sr-TransMax indicates the maximum number of times that the UE 101 can transmit the SR to the serving cell 102.

If the SR transmission counter is less than the sr-TransMax, the MAC entity 101A can check if there is at least one valid PUCCH resource available for the physical layer 101B to transmit the SR to the serving cell 102. In an embodiment herein, only PUCCH resources on a Bandwidth Part (BWP), which is active at the time of attempting to transmit the SR transmission, are considered valid by the MAC entity 101A. The BWP can be considered inactive by the MAC entity 101A, during the time when the cell to which BWP corresponds to is in the Cell-DRX and/or Cell-DTX state. Further, the BWP is considered active by the MAC entity 101A, when the cell to which BWP corresponds comes out of Cell-DRX state and/or Cell-DTX state. In an embodiment herein, only PUCCH resources on a BWP, which is active, and the serving cell is not in Cell-DRX state at the time of SR transmission, are considered valid by the MAC entity 101A; i.e., PUCCH resources on a BWP, which is not active, or the serving cell is in Cell-DRX state at the time of SR transmission, are considered invalid. In an embodiment herein, for a SR configuration, the MAC entity 101A can consider only those PUCCH resources for BWP(s) and cell(s) for SR transmission, wherein the cell(s) are not in Cell-DRX state at the time of SR transmission. In an embodiment herein, for a SR configuration, the MAC entity 101A can determine the valid PUCCH resource(s) and the invalid PUCCH resource(s) based on the Cell-DRX state of the pertinent cell(s) at the time of SR transmission and can consider SR transmission on at least one of the valid PUCCH resources.

If there is at least one valid PUCCH resource available for the physical layer 101B to transmit the SR to the serving cell 102, the MAC entity 101A can check if the serving cell 102 is in the Cell-DRX state. If the serving cell 102 is not in the Cell-DRX state, the MAC entity 101A can instruct the physical layer 101B to transmit the SR to the serving cell 102.

If the serving cell 102 is in the Cell-DRX state, the MAC entity 101A can defer instructing the physical entity 101B to transmit the SR entity to the serving cell 102; i.e., the UE 101 does not transmit the SR to the serving cell 102. The MAC entity 101A can keep the SR as pending (i.e., the SR is not cancelled). Further, the MAC entity 101A can keep the SR transmission counter intact; i.e., the SR transmission counter is not incremented. In an embodiment herein, the MAC entity 101A does not reset the SR transmission counter. Further, the MAC entity 101A can keep a sr-ProhibitTimer intact; i.e., the MAC entity 101A does not start the sr-ProhibitTimer. In an embodiment herein, the MAC entity 101A can keep the sr-ProhibitTimer running, if the sr-ProhibitTimer has already been running.

In an embodiment, as long as at least one SR is pending, for each pending SR, if the MAC entity 101A has no valid PUCCH resource configured for the pending SR and if the serving cell (for example, Special cell (also termed as SpCell)) is not in Cell-DRX state, the MAC entity 101A can initiate a Random Access procedure on the SpCell and cancels the pending SR. The SpCell can comprise of a primary cell (PCell) of the Master Cell Group (MCG) and a Secondary primary cell (PsCell) of the Secondary Cell Group (SCG)

In an example embodiment, an enhancement for transmitting SR is provided according to TS 38.321 section 5.4.4. As long as at least one SR is pending, the MAC entity 101A shall for each pending SR:
1> if the MAC entity has no valid PUCCH resource configured for the pending SR and if the serving cell (e.g. SpCell) is not in Cell-DRX state:
   2> initiate a Random Access procedure (see clause 5.1) on the SpCell and cancel the pending SR.

In an embodiment, as long as at least one SR is pending, for each pending SR (if the MAC entity 101A has no valid PUCCH resource configured for the pending SR and if the serving cell (for example, SpCell) is in Cell-DRX state, the MAC entity 101A can defer initiating a Random Access procedure on the SpCell and defer cancelling the pending SR until the serving cell (for example, SpCell) comes out of the Cell-DRX state.

In an example embodiment, an enhancement for transmitting SR is provided, according to TS 38.321 section 5.4.4. As long as at least one SR is pending, the MAC entity 101A shall for each pending SR:
1> if the MAC entity has no valid PUCCH resource configured for the pending SR and if the serving cell (e.g. SpCell) is in Cell-DRX state:
   2> defer initiating a Random Access procedure (see clause 5.1) on the SpCell and cancelling the pending SR until the serving cell (e.g. SpCell) comes out to Cell-DRX state.

In an embodiment herein, if the SR_COUNTER is equal to or greater than sr-TransMax, and if the serving cell is in the Cell-DRX state, the MAC entity 101A can defer initiating a Random Access procedure on the SpCell. The MAC entity 101A can further defer cancelling all pending SRs until the serving cell 102 comes out of the Cell-DRX state. Further, in this scenario, the MAC entity 101A may perform one of immediately or defer:
notifying Radio Resource Control (RRC) to release PUCCH for all serving cells,
notifying RRC to release Sounding Reference Signal (SRS) for all serving cell,
clearing any configured downlink assignments and uplink grants, and
clearing any PUSCH resources for semi-persistent Channel State Information (CSI) reporting.

In an embodiment herein, the MAC entity may pursue the triggering of the Random Access procedure and cancel the pending SR, if the emergency service is initiated and the serving cell (e.g. SpCell) is not in the Cell-DRX state. In an embodiment, the pending SR for the Buffer status Report (BSR) triggered for the emergency service is cancelled and other pending SR(s) are not cancelled upon initiation of the Random Access procedure if the emergency service is initiated and the serving cell (e.g. SpCell) is not in the Cell-DRX state. In another embodiment, all the pending SR(s) are cancelled upon initiation of the Random Access procedure if the emergency service is initiated and the serving cell (e.g. SpCell) is not in the Cell-DRX state. In another embodiment, all the pending SR(s) are cancelled upon sending of the MAC Protocol Data Unit (PDU) comprising the BSR MAC Control Element (CE) which contains buffer status up to and including the last event that triggered a BSR (e.g. the BSR initiated for the Random Access procedure if the emergency service and the serving cell (e.g. SpCell) is not in the Cell-DRX state). In another embodiment, all the pending SR(s) are cancelled when uplink grant received can accommodate all pending data available for transmission.

In an example embodiment, an enhancement for handling SR is provided, according to TS 38.321
1> if cell DRX is activated and the Serving Cell is not in the cell DRX Active Period:
   2> not instruct the physical layer to signal a SR on a PUCCH resource for SR;
   2> not increment the SR_COUNTER for a SR;
   2> not start the sr-ProhibitTimer for a SR;
   2> not deliver any configured uplink grant and the associated HARQ information to the HARQ entity;
   2> not instruct a HARQ process associated with a configured uplink grant to trigger a new transmission or a retransmission;
   2> not report periodic CSI and semi-persistent CSI.
   2> if an emergency service is initiated by upper layers:
      3> initiate a Random Access procedure (as specified in clause 5.1.1) and cancel the pending SR.

In an embodiment herein, the MAC entity 101A can one of stop or suspend an ongoing Random Access procedure (if any), if the serving cell goes to the Cell-DRX state. The MAC entity 101A can (re-)initiate or resume the Random Access procedure, when the serving cell comes out of the Cell-DRX state.

In an embodiment herein, the MAC entity 101A can continue an ongoing Random Access procedure (if any), if the serving cell goes to the Cell-DRX state.

In an embodiment herein, the MAC entity 101A may one of stop or suspend an ongoing Random Access procedure (if any), due to a pending SR for Buffer Status Report (BSR), which was initiated by the MAC entity prior to the MAC Packet Data Unit (PDU) assembly, and which has no valid PUCCH resources configured, if/when the serving cell 102 goes to Cell-DRX state. The MAC entity 101A may (re-)initiate or resume the Random Access procedure, when the serving cell 102 comes out of the Cell-DRX state.

In an embodiment herein, the MAC entity 101A may one of stop or suspend an ongoing Random Access procedure (if any), due to a pending SR for sidelink-Buffer Status Report (SL-BSR) and/or sidelink-Channel State Information (SL-CSI) reporting, which was initiated by the MAC entity prior to the sidelink MAC PDU assembly, and which has no valid PUCCH resources configured, if/when the serving cell goes to the Cell-DRX state. The MAC entity 101A may (re-)initiate or resume the Random Access procedure, when the serving cell comes out of the Cell-DRX state.

In an embodiment herein, the MAC entity 101A may one of stop or suspend an ongoing Random Access procedure (if any), due to a pending SR for Beam Failure Recovery (BFR) of a serving cell (which has no valid PUCCH resources configured), if/when the serving cell 102 goes to the Cell-DRX state. The MAC entity 101A may (re-)initiate or resume the Random Access procedure, when the serving cell 102 comes out of the Cell-DRX state.

In an embodiment herein, the MAC entity 101A may one of stop or suspend an ongoing Random Access procedure (if any), due to a pending SR for BFR of a Beam Failure Detection-Reference Signal (BFD-RS) set of the serving cell 102, which has no valid PUCCH resources configured, if/when the serving cell 102 goes to the Cell-DRX state. The MAC entity 101A may (re-)initiate or resume the Random Access procedure, when the serving cell 102 comes out of the Cell-DRX state.

In an embodiment herein, the MAC entity 101A may one of stop or suspend an ongoing Random Access procedure (if any), due to a pending SR for consistent Listen-Before-Talk (LBT) failure recovery, which has no valid PUCCH resources configured, if/when the serving cell 102 goes to the Cell-DRX state. The MAC entity 101A may (re-)initiate or resume the Random Access procedure, when the serving cell 102 comes out of the Cell-DRX state.

In an embodiment herein, the MAC entity 101A may one of stop or suspend an ongoing Random Access procedure (if any), due to a pending SR for positioning measurement gap activation/deactivation request, which has no valid PUCCH resources configured, if/when the serving cell 102 goes to the Cell-DRX state. The MAC entity 101A may (re-)initiate or resume the Random Access procedure, when the serving cell 102 comes out of the Cell-DRX state.

In an embodiment herein, the MAC entity 101A may one of stop or suspend an ongoing Random Access procedure (if any), due to a pending SR for Timing Advance report, which has no valid PUCCH resources configured, if/when the serving cell 102 goes to the Cell-DRX state. The MAC entity 101A may (re-)initiate or resume the Random Access procedure, when the serving cell 102 comes out of the Cell-DRX.

In an embodiment herein, the MAC entity 101A for the UE 101 can be configured with a signalling parameter (hereinafter referred to as “nes-SR-Mask”/“nes-RA-Mask”/“nes-SR-RS-Mask”) by a cell. If the signalling parameter is configured and set to TRUE, the MAC entity 101A can mask the transmission of SR and/or triggering of Random Access procedure at the time, when that cell is configured and/or activated to be in the Cell-DRX state. The cell can provide the signalling parameter to the UE 101 in a RRC reconfiguration message; for example, the cell can provide the signalling parameter to the UE 101 in a MAC-cellConfig IE with an indication for the applicable cells of the cell group for the MAC entity 101A. Further, the signalling parameter may also be configured per logical channel (for example, in the LogicalChannelConfig IE).

In an embodiment herein, the MAC entity 101A can pursue the transmission of SR and/or triggering of Random Access procedure on to another cell (i.e., one of the other cells which at the given time is not configured and/or not activated to be in Cell-DRX state and/or Cell-DTX state). In an embodiment herein, the MAC entity 101A can utilize the same SR configuration (as used by the UE 101, when attempting to transmit to the serving cell 102) for transmitting the SR to another cell. In an embodiment herein, for transmitting the SR to another cell, the MAC entity 101A can utilize a different SR configuration for which PUCCH and BWP resources pertain to at least one of a cell which at the given time is not configured and/or not activated to be in Cell-DRX state and/or Cell-DTX state. The MAC entity 101A can apply the behaviour to the SR transmission that is triggered due to at least one of data arrival on a logical channel (i.e., BSR triggering), SCell beam failure recovery, beam failure recovery of BFD-RS set, consistent LBT failure recovery, positioning measurement gap activation/deactivation request, Pre-emptive SR, and Timing Advance reporting.

In an embodiment herein, the MAC entity 101A for the UE 101 can skip considering a pending SR as a prioritized SR, when the serving cell 102 (or cell(s) corresponding to the SR configuration) is in the Cell-DRX state.

In an embodiment herein, handling for triggering of SR is disclosed herein, when the BSR reporting procedure is undertaken as below:
1> if the Buffer Status reporting procedure determines that at least one BSR has been triggered and not cancelled:
   2> if a Regular BSR has been triggered and logicalChannelSR-DelayTimer is not running and serving cell is not in Cell-DRX state:
      3> if there is no UL-SCH resource available for a new transmission; or
      3> if the MAC entity is configured with configured uplink grant(s) and the Regular BSR was triggered for a logical channel for which logicalChannelSR-Mask is set to false; or
      3> if the UL-SCH resources available for a new transmission do not meet the LCP mapping restrictions (see clause 5.4.3.1) configured for the logical channel that triggered the BSR:
         4> trigger a Scheduling Request.

In an example embodiment herein, an enhancement for transmitting SR is provided according to TS 38.321:

The MAC entity shall, on the Serving Cell(s) in Cell-DRX state and/or Cell-DTX state:
1> Not perform the transmission of SR

In an example embodiment herein, an enhancement for transmitting SR is provided according to TS 38.321 section 5.4.4.

As long as at least one SR is pending, the MAC entity shall for each pending SR:
1> if the MAC entity has no valid PUCCH resource configured for the pending SR:
   2> initiate a Random Access procedure (see clause 5.1) on the SpCell and cancel the pending SR.
1> else, for the SR configuration corresponding to the pending SR:
   2> when the MAC entity has an SR transmission occasion on the valid PUCCH resource for SR configured; and
   2> if sr-ProhibitTimer is not running at the time of the SR transmission occasion; and
   2> if the PUCCH resource for the SR transmission occasion does not overlap with a measurement gap and the serving cell is not in Cell-DRX state:
      3> if the PUCCH resource for the SR transmission occasion overlaps with neither a UL-SCH resource whose simultaneous transmission with the SR is not allowed by configuration of simultaneousPUCCH-PUSCH or simultaneousPUCCHPUSCH-SecondaryPUCCHgroup or simultaneousSR-PUSCH-diffPUCCH-Groups nor an SL-SCH resource; or
      3> if the MAC entity is able to perform this SR transmission simultaneously with the transmission of the SL-SCH resource; or
      3> if the MAC entity is configured with Ich-basedPrioritization, and the PUCCH resource for the SR transmission occasion does not overlap with the PUSCH duration of an uplink grant received in a Random Access Response or with the PUSCH duration of an uplink grant addressed to Temporary C-RNTI or with the PUSCH duration of a MSGA payload, and the PUCCH resource for the SR transmission occasion for the pending SR triggered as specified in clause 5.4.5 overlaps with any other UL-SCH resource(s), and the physical layer can signal the SR on one valid PUCCH resource for SR, and the priority of the logical channel that triggered SR is higher than the priority of the uplink grant(s) for any UL-SCH resource(s) where the uplink grant was not already de-prioritized and its simultaneous transmission with the SR is not allowed by configuration of simultaneousPUCCH-PUSCH or simultaneousPUCCHPUSCH-SecondaryPUCCHgroup or simultaneousSR-PUSCH-diffPUCCHgroups, and the priority of the uplink grant is determined as specified in clause 5.4.1; or
      3> if both sl-PrioritizationThres and ul-PrioritizationThres are configured and the PUCCH resource for the SR transmission occasion for the pending SR triggered as specified in clause 5.22.1.5 overlaps with any UL-SCH resource(s) carrying a MAC PDU, and the value of the priority of the triggered SR determined as specified in clause 5.22.1.5 is lower than sl-PrioritizationThres and the value of the highest priority of the logical channel(s) in the MAC PDU is higher than or equal to ul-PrioritizationThres and any MAC CE prioritized as described in clause 5.4.3.1.3 is not included in the MAC PDU and the MAC PDU is not prioritized by upper layer according to TS 23.287 [19]; or
      3> if an SL-SCH resource overlaps with the PUCCH resource for the SR transmission occasion for the pending SR triggered as specified in clause 5.4.5, and the MAC entity is not able to perform this SR transmission simultaneously with the transmission of the SL-SCH resource, and either transmission on the SL-SCH resource is not prioritized as described in clause 5.22.1.3.1a or the priority value of the logical channel that triggered SR is lower than ul-PrioritizationThres, if configured; or
      3> if an SL-SCH resource overlaps with the PUCCH resource for the SR transmission occasion for the pending SR triggered as specified in clause 5.22.1.5, and the MAC entity is not able to perform this SR transmission simultaneously with the transmission of the SL-SCH resource, and the priority of the triggered SR determined as specified in clause 5.22.1.5 is higher than the priority of the MAC PDU determined as specified in clause 5.22.1.3.1a for the SL-SCH resource:
         4> consider the SR transmission as a prioritized SR transmission.
         4> consider the other overlapping uplink grant(s), if any, as a de-prioritized uplink grant(s), except for the overlapping uplink grant(s) whose simultaneous transmission is allowed by configuration of simultaneousPUCCH-PUSCH or simultaneousPUCCH-PUSCH-SecondaryPUCCHgroup or simultaneousSRPUSCH-diffPUCCH-Groups;
         4> if the de-prioritized uplink grant(s) is a configured uplink grant configured with autonomousTx whose PUSCH has already started:
         5> stop the configuredGrantTimer for the corresponding HARQ process of the de-prioritized uplink grant(s);
         5> stop the cg-RetransmissionTimer for the corresponding HARQ process of the de-prioritized uplink grant(s).
         4> if SR_COUNTER<sr-TransMax:
         5> instruct the physical layer to signal the SR on one valid PUCCH resource for SR;
         5> if LBT failure indication is not received from lower layers:
         6> increment SR_COUNTER by 1;
         6> start the sr-ProhibitTimer.
         5> else if lbt-FailureRecoveryConfig is not configured:
         6> increment SR_COUNTER by 1.
         4> else:
         5> notify RRC to release PUCCH for all Serving Cells;
         5> notify RRC to release SRS for all Serving Cells;
         5> clear any configured downlink assignments and uplink grants;
         5> clear any PUSCH resources for semi-persistent CSI reporting;
         5> initiate a Random Access procedure (see clause 5.1) on the SpCell and cancel all pending SRs.
      3> else:
         4> consider the SR transmission as a de-prioritized SR transmission.

The memory 101C can also store instructions to be executed by the MAC entity 101A and the physical entity 101B. The memory 101C may include non-volatile storage elements. Examples of such non-volatile storage elements may include magnetic hard discs, optical discs, floppy discs, flash memories, or forms of electrically programmable memories (EPROM) or electrically erasable and programmable (EEPROM) memories. In addition, the memory 101C may, in some examples, be considered a non-transitory storage medium. The term “non-transitory” may indicate that the storage medium is not embodied in a carrier wave or a propagated signal. However, the term “non-transitory” should not be interpreted that the memory 101C is non-movable. In certain examples, a non-transitory storage medium may store data that can, over time, change (e.g., in Random Access Memory (RAM) or cache). The memory 101C can store one or more additional parameters, timers, and other information. Examples of the information can be, but not limited to, pending SRs, the periodicity parameter; the start slot/offset parameter; the on-duration window parameter; the on-duration timer parameter, and any other parameter(s) in the NES configuration. Examples of the timer can be, but not limited to, the SR transmission counter, the sr-ProhibitTimer, and so on.

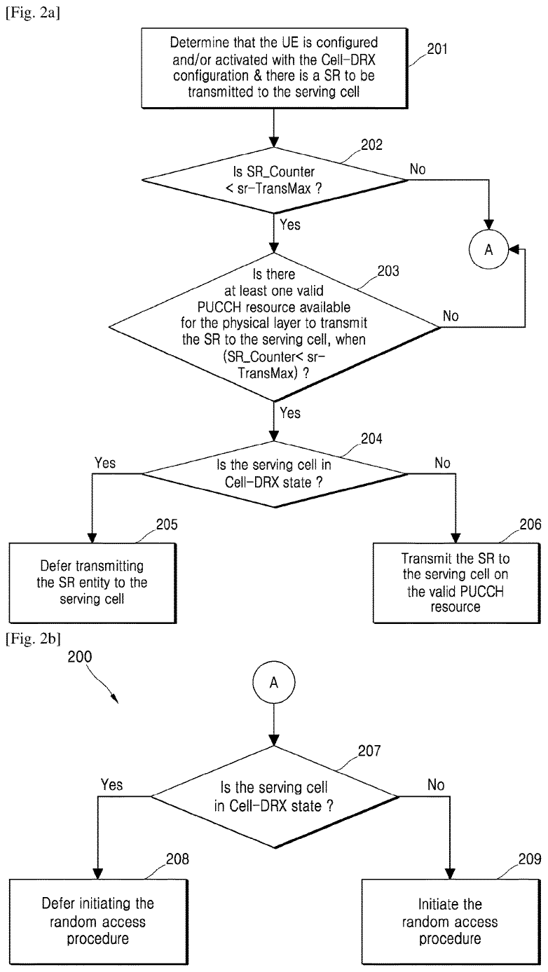

FIGS. 2A and 2B depict a process for managing the transmission of SRs to a serving cell. In step 201, the UE 101 determines that the UE 101 is configured and/or activated with the Cell-DRX configuration. On determining that it is configured and/or activated with the Cell-DRX configuration and if there is a SR to be transmitted to the serving cell 102, in step 202, the UE 101 determines if the value of the SR transmission counter (SR_Counter) is less than the pre-defined or pre-configured threshold (sr-TransMax). If the value of the SR transmission counter (SR_Counter) is less than sr-TransMax, in step 203, the UE 101 checks if there is at least one valid PUCCH resource configured and/or available for the physical layer 101B to transmit the SR to the serving cell 102. If there is at least one valid PUCCH resource configured and/or available for the physical layer 101B to transmit the SR to the serving cell 102, in step 204, the UE 101 checks if the serving cell 102 is in the Cell-DRX state. If the serving cell 102 is in the Cell-DRX state, in step 205, the UE 101 defers transmitting the SR entity to the serving cell 102; i.e., the UE 101 does not transmit the SR to the serving cell 102. If the serving cell 102 is not in the Cell-DRX state, in step 206, the UE 101 transmits the SR to the serving cell 102 on the valid PUCCH resource.

If the value of the SR transmission counter (SR_Counter) is less than the sr-TransMax or there is no valid PUCCH resource is configured or available for the physical layer 101B to transmit the SR to the serving cell 102, in step 207, the UE 101 checks if the serving cell 102 is in the Cell-DRX state. If the serving cell 102 is in the Cell-DRX state, in step 208, the UE 101 defers initiating the random access procedure until the serving cell comes out of the Cell-DRX state. If the serving cell 102 is not in the Cell-DRX state, in step 208, the UE 101 initiates the random access procedure. The various actions in method 200 may be performed in the order presented, in a different order or simultaneously. Further, in some embodiments, some actions listed in FIGS. 2A and 2B may be omitted.

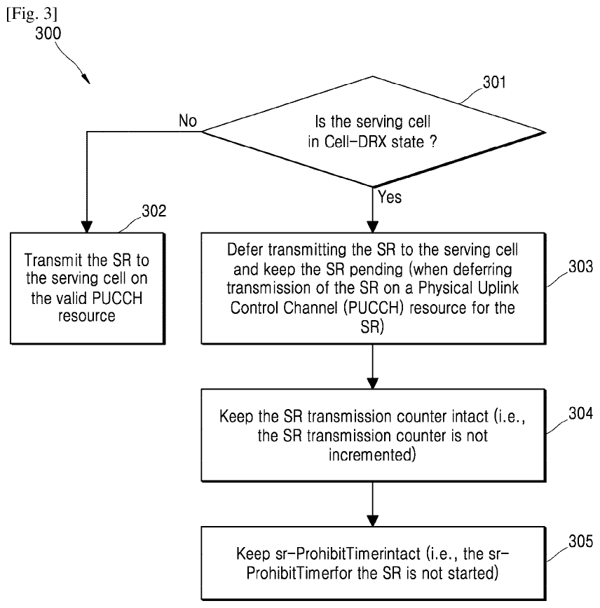

FIG. 3 is a flowchart depicting the process of the UE determining whether to transmit the SR based on the Cell-DRX state of the serving cell. In step 301, the UE 101 determines if the serving cell 102 is in the Cell-DRX state. In an embodiment herein, the UE 101 can determine if the serving cell 102 is in the Cell-DRX state, if the UE 101 is at least one of configured; and activated with NES mode by the serving cell 102. In an embodiment herein, the UE 101 can determine if the serving cell 102 is in the Cell-DRX state, if the UE 101 is at least one of configured and activated with at least one NES configuration by the serving cell. The NES configuration comprises a Cell-DRX configuration. In an embodiment herein, the UE 101 can determine if the serving cell 102 is in the Cell-DRX state, if the UE 101 is operating in a network node employing NES mode. The UE 101 can further determine the time duration, when the cell is in the Cell-DRX state, based on at least one parameter in the NES configuration. The parameter in the NES configuration can be at least one of the periodicity parameter; the start slot/offset parameter; the on-duration window parameter; and the on-duration timer parameter. If the cell is not in the Cell-DRX state, in step 302, the UE 101 transmits the SR to the serving cell on the valid PUCCH (if the value of the SR transmission counter (SR_Counter) is less than the pre-defined or pre-configured threshold (sr-TransMax)). The valid PUCCH is a PUCCH resource on an active Bandwidth Part (BWP), and the serving cell is not in the Cell-DRX state at the time of transmitting the SR. If the serving cell 102 is in the Cell-DRX state, in step 303, the UE 101 defers transmitting the SR to the serving cell and keeps the SR as pending. In step 304, the UE 101 further keeps the SR transmission counter intact, wherein UE 101 does not increment the SR transmission counter. In step 305, the UE 101 further keeps the sr-ProhibitTimer intact, wherein the UE 101 does not start the sr-ProhibitTimer for the SR. The various actions in method 300 may be performed in the order presented, in a different order or simultaneously. Further, in some embodiments, some actions listed in FIG. 3 may be omitted.

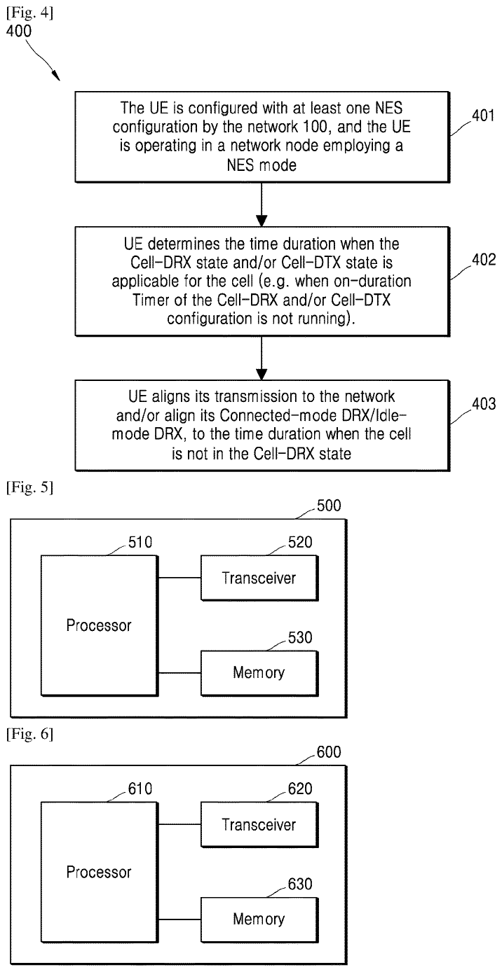

FIG. 4 is a flowchart depicting the process of the UE determining that the network is in a Cell-DRX state, based on the Cell-DRX configuration parameter (on-durationTimer). Consider that in step 401, the UE 101 is configured with at least one NES configuration by the network 100, and the UE 101 is operating in a network node employing a NES mode. The NES configuration can comprise of one or more Cell-DRX and/or Cell-DTX configurations that can be applied together or independently. The Cell-DRX and/or Cell-DTX configurations may be configured and/or activated and/or deactivated per cell basis for one or more cells. The Cell-DRX and/or Cell-DTX configuration further comprises of the on-duration Timer parameter. Based on the on-duration Timer parameter, in step 402, the UE 101 determines the time duration when the Cell-DRX state and/or Cell-DTX state is applicable for the cell (e.g. when on-duration Timer of the Cell-DRX and/or Cell-DTX configuration is not running). In step 403, the UE 101 aligns its transmission to the network and/or align its Connected-mode DRX/Idle-mode DRX, to the time duration when the cell is not in the Cell-DRX state. The various actions in method 400 may be performed in the order presented, in a different order or simultaneously. Further, in some embodiments, some actions listed in FIG. 4 may be omitted.

FIG. 5 is a diagram illustrating a UE 500 according to another embodiment of the present disclosure.

Referring to the FIG. 5, the UE 500 may include a processor 510, a transceiver 520 and a memory 530. However, all of the illustrated components are not essential. The UE 500 may be implemented by more or less components than those illustrated in FIG. 5. In addition, the processor 510 and the transceiver 520 and the memory 530 may be implemented as a single chip according to another embodiment.

The aforementioned components will now be described in detail.

The processor 510 may include one or more processors or other processing devices that control the proposed function, process, and/or method. Operation of the UE 500 may be implemented by the processor 510.

The processor 510 may perform operations of UE aforementioned based on FIG. 1 to FIG. 4.

The transceiver 520 may include a RF transmitter for up-converting and amplifying a transmitted signal, and a RF receiver for down-converting a frequency of a received signal. However, according to another embodiment, the transceiver 520 may be implemented by more or less components than those illustrated in components.

The transceiver 520 may be connected to the processor 510 and transmit and/or receive a signal. The signal may include control information and data. In addition, the transceiver 520 may receive the signal through a wireless channel and output the signal to the processor 510. The transceiver 520 may transmit a signal output from the processor 510 through the wireless channel.

The memory 530 may store the control information or the data included in a signal obtained by the UE 500. The memory 530 may be connected to the processor 510 and store at least one instruction or a protocol or a parameter for the proposed function, process, and/or method. The memory 530 may include read-only memory (ROM) and/or random access memory (RAM) and/or hard disk and/or CD-ROM and/or DVD and/or other storage devices.

FIG. 6 is a diagram illustrating a base station 600 according to another embodiment of the present disclosure.

Referring to the FIG. 6, the base station 600 may include a processor 610, a transceiver 620 and a memory 630. However, all of the illustrated components are not essential, the base station 600 may be implemented by more or less components than those illustrated in FIG. 6. In addition, the processor 610 and the transceiver 620 and the memory 630 may be implemented as a single chip according to another embodiment.

The aforementioned components will now be described in detail.

The processor 610 may include one or more processors or other processing devices that control the proposed function, process, and/or method. Operation of the base station 600 may be implemented by the processor 610.

The processor 610 may perform operations of the base station aforementioned based on FIG. 1 to FIG. 4.

The transceiver 620 may be connected to the processor 610 and transmit and/or receive a signal. The signal may include control information and data. In addition, the transceiver 620 may receive the signal through a wireless channel and output the signal to the processor 610. The transceiver 620 may transmit a signal output from the processor 610 through the wireless channel.

The memory 630 may store the control information or the data included in a signal obtained by the base station 600. The memory 630 may be connected to the processor 610 and store at least one instruction or a protocol or a parameter for the proposed function, process, and/or method. The memory 630 may include read-only memory (ROM) and/or random access memory (RAM) and/or hard disk and/or CD-ROM and/or DVD and/or other storage devices.

The embodiments disclosed herein can be implemented through at least one software program running on at least one hardware device and performing network management functions to control the network elements. The elements include blocks which can be at least one of a hardware device, or a combination of hardware device and software module.

The embodiment disclosed herein describes methods and systems for managing Scheduling Request (SR) for Network Energy Saving (NES) in a wireless communication network. Therefore, it is understood that the scope of the protection is extended to such a program and in addition to a computer readable means having a message therein, such computer readable storage means contain program code means for implementation of one or more steps of the method, when the program runs on a server or mobile device or any suitable programmable device. The method is implemented in at least one embodiment through or together with a software program written in e.g., Very high speed integrated circuit Hardware Description Language (VHDL) another programming language, or implemented by one or more VHDL or several software modules being executed on at least one hardware device. The hardware device can be any kind of portable device that can be programmed. The device may also include means which could be e.g., hardware means like e.g., an ASIC, or a combination of hardware and software means, e.g., an ASIC and an FPGA, or at least one microprocessor and at least one memory with software modules located therein. The method embodiments described herein could be implemented partly in hardware and partly in software. Alternatively, the invention may be implemented on different hardware devices, e.g., using a plurality of CPUs.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of embodiments and examples, those skilled in the art will recognize that the embodiments and examples disclosed herein can be practiced with modification within the scope of the embodiments as described herein.

1-15. (canceled)

16. A method performed by a user equipment (UE) in a wireless communication system, the method comprising:
receiving, from a base station, configuration information for a cell discontinuous reception (DRX);
identifying that a scheduling request (SR) is triggered;
identifying whether the cell DRX is activated and a serving cell is not in an active reception period of the cell DRX based on the configuration information; and
in case that the cell DRX is activated and the serving cell is not in the active reception period of the cell DRX, determining not to transmit the SR.

17. The method of claim 16, wherein the configuration information includes at least one of periodicity, start slot, start offset, and on-duration timer.

18. The method of claim 16, further comprising:
in case that the cell DRX is activated and the serving cell is not in the active reception period of the cell DRX:
determining not to increase a SR counter for the SR; and
determining not to start a SR prohibit timer for the SR.

19. The method of claim 16, wherein in case that the cell DRX is activated and the serving cell is not in the active reception period of the cell DRX, a random access procedure is not initiated.

20. A method performed by a base station in a wireless communication system, the method comprising:
transmitting, to a user equipment (UE), configuration information for a cell discontinuous reception (DRX);
identifying whether the cell DRX is activated and a serving cell is not in an active reception period of the cell DRX according to the configuration information; and
in case that the cell DRX is activated and the serving cell is not in the active reception period of the cell DRX, determining not to receive a scheduling request (SR).

21. The method of claim 20, wherein the configuration information includes at least one of periodicity, start slot, start offset, and on-duration timer.

22. The method of claim 20, wherein a SR counter for the SR is not increased and a SR prohibit timer for the SR is not started.

23. The method of claim 20, wherein in case that the cell DRX is activated and the serving cell is not in the active reception period of the cell DRX, a random access procedure is not initiated.

24. A user equipment (UE) comprising:
a transceiver; and
a processor coupled with the transceiver and configured to:
receive, from a base station via the transceiver, configuration information for a cell discontinuous reception (DRX),
identify that a scheduling request (SR) is triggered,
identify whether the cell DRX is activated and a serving cell is not in an active reception period of the cell DRX based on the configuration information, and
in case that the cell DRX is activated and the serving cell is not in the active reception period of the cell DRX, determine not to transmit the SR.

25. The UE of claim 24, wherein the configuration information includes at least one of periodicity, start slot, start offset, and on-duration timer.

26. The UE of claim 24, wherein the processor is further configured to:
in case that the cell DRX is activated and the serving cell is not in the active reception period of the cell DRX:
determine not to increase a SR counter for the SR, and
determine not to start a SR prohibit timer for the SR.

27. The UE of claim 24, wherein in case that the cell DRX is activated and the serving cell is not in the active reception period of the cell DRX, a random access procedure is not initiated.

28. A base station comprising:
a transceiver; and
a processor coupled with the transceiver and configured to:
transmit, to a user equipment (UE) via the transceiver, configuration information for a cell discontinuous reception (DRX),
identify whether the cell DRX is activated and a serving cell is not in an active reception period of the cell DRX according to the configuration information, and
in case that the cell DRX is activated and the serving cell is not in the active reception period of the cell DRX, determine not to receive a scheduling request (SR).

29. The base station of claim 28, wherein the configuration information includes at least one of periodicity, start slot, start offset, and on-duration timer.

30. The base station of claim 28, wherein a SR counter for the SR is not increased and a SR prohibit timer for the SR is not started.
